(19) United States
(12) Patent Application Publication
(10) Pub. No.: US 2026/0211173 A1
(43) Pub. Date: Jul. 23, 2026

(54) OPTICAL WAVEGUIDE PACKAGE AND LIGHT SOURCE MODULE

(71) Applicant: KYOCERA Corporation, Kyoto-shi, Kyoto (JP)

(72) Inventors: Shougo MATSUNAGA, Kirishima-shi, Kagoshima (JP); Yoshiaki ITAKURA, Aira-shi, Kagoshima (JP)

(73) Assignee: KYOCERA Corporation, Kyoto-shi, Kyoto (JP)

(21) Appl. No.: 19/142,700

(22) PCT Filed: Dec. 27, 2023
(86) PCT No.: PCT/JP2023/046990

§ 371 Date: Jun. 24, 2025

(30) Foreign Application Priority Data
Dec. 28, 2022 (JP) 2022-211754

(51) Int. Cl. F21V 8/00

(52) U.S. Cl. CPC G02B 6/0091

(57) ABSTRACT

An optical waveguide package includes a substrate including a first surface, a cladding on the first surface, a core inside the cladding, and a metal film on the cladding. The cladding includes a second surface facing the first surface, a third surface opposite the second surface, a fourth surface between the second surface and the third surface and adjacent to the third surface, and an element mount being open in the third surface. The core includes an incident surface exposed on the element mount and an emission surface exposed from an end face of the cladding. The metal film surrounds the element mount and includes a first portion on the third surface and a second portion on the fourth surface.

### TECHNICAL FIELD

The present disclosure relates to an optical waveguide package and a light source module.

### BACKGROUND OF INVENTION

A known technique for an optical waveguide package is described in, for example, Patent Literature 1.

### CITATION LIST

### Patent Literature

Patent Literature 1: Japanese Unexamined Patent Application Publication No. 10-54917

### SUMMARY

In an aspect of the present disclosure, an optical waveguide package includes a substrate including a first surface, a cladding on the first surface, a core inside the cladding, and a metal film on the cladding. The cladding includes a second surface facing the first surface, a third surface opposite the second surface, a fourth surface between the second surface and the third surface and adjacent to the third surface, and an element mount being open in the third surface. The core includes an incident surface exposed on the element mount and an emission surface exposed from an end face of the cladding. The metal film surrounds the element mount. The metal film includes a first portion on the third surface and a second portion on the fourth surface.

In an aspect of the present disclosure, a light source module includes the optical waveguide package described above, a light-emitting element on the element mount in the optical waveguide package, and a lid bonded to the metal film and covering the element mount.

### BRIEF DESCRIPTION OF THE DRAWINGS

The objects, features, and advantages of the present disclosure will become more apparent from the following detailed description and the drawings.

FIG. 1 is an exploded perspective view of a light source module including an optical waveguide package according to one embodiment of the present disclosure.

FIG. 2 is a plan view of the light source module illustrated in FIG. 1.

FIG. 3 is a cross-sectional view taken along section line III-III in FIG. 2.

FIG. 4 is a partially enlarged perspective view of section IV in FIG. 2, illustrating a metal film mounted on a cladding.

FIG. 5 is a partially enlarged perspective view of a metal film in an optical waveguide package according to another embodiment of the present disclosure.

FIG. 6 is a partially enlarged perspective view of a metal film in an optical waveguide package according to another embodiment of the present disclosure.

FIG. 7 is an enlarged cross-sectional view of a metal film in an optical waveguide package according to still another embodiment of the present disclosure, schematically illustrating a stacking structure of the metal film.

FIG. 8 is a partially enlarged perspective view of an optical waveguide package according to still another embodiment of the present disclosure.

### DESCRIPTION OF EMBODIMENTS

Patent Literature 1 describes a structure including an optical waveguide including a core and a cladding surrounding the core on a substrate, a groove extending in a direction intersecting with the optical waveguide, and a light-blocking film on an inner wall of the groove. This structure lowers the likelihood of leaking of, into the core facing a light-emitting element in a cladding mode, light in a radiation mode generated inside the optical waveguide element.

With the known technique described in Patent Literature 1, the substrate may deform due to heat generated during, for example, the mounting of the light-emitting element on the substrate, causing an optical axis of the light-emitting element to misalign with an axis of the core in the optical waveguide and possibly lowering the optical propagation efficiency between the core and the light-emitting element. Optical waveguide packages and light source modules with improved optical propagation efficiency have thus been awaited.

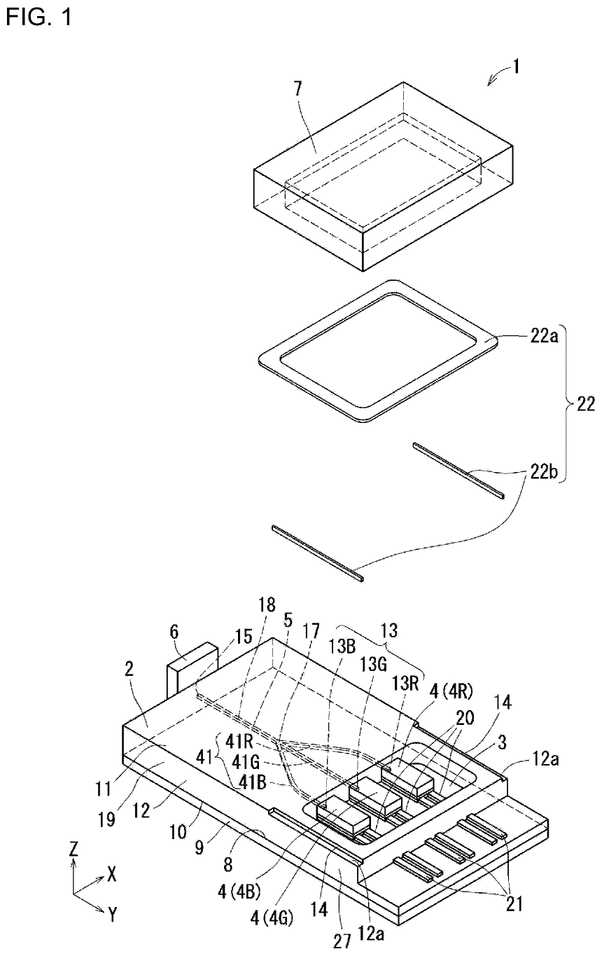

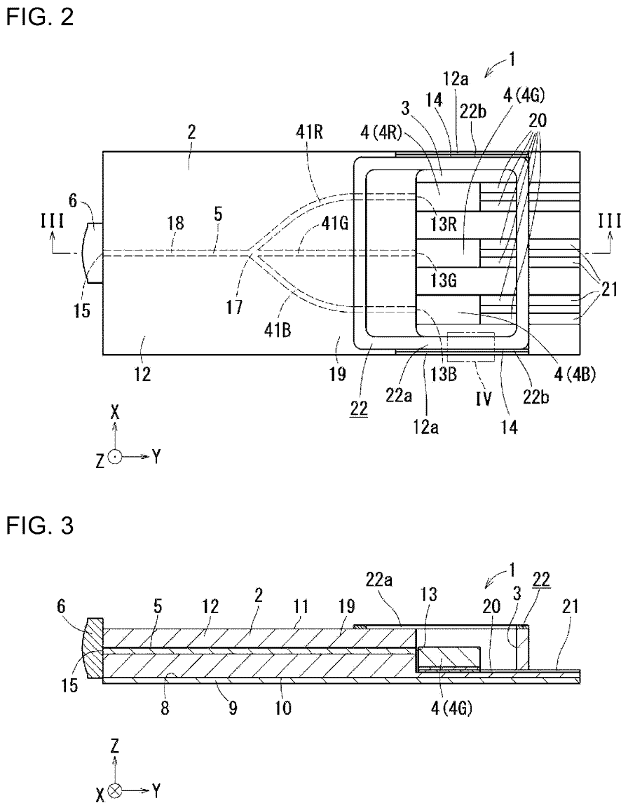

FIG. 1 is an exploded perspective view of a light source module 1 including an optical waveguide package 2 according to one embodiment of the present disclosure. FIG. 2 is a plan view of the light source module 1 illustrated in FIG. 1. FIG. 3 is a cross-sectional view taken along section line III-III in FIG. 2. Note that the drawings used hereafter are schematic and are not necessarily drawn to scale relative to the actual size of each component in the drawings. Although the optical waveguide package 2 and the light source module 1 according to one or more embodiments of the present disclosure may be oriented with any sides being upward or downward, the optical waveguide package 2 and the light source module 1 herein are defined using the orthogonal coordinate system (X, Y, and Z) for convenience, with a positive Z-direction being upward and directional terms such as an upper surface or a lower surface used accordingly. An X-direction is also referred to as a length direction. A Y-direction is also referred to as a width direction. A Z-direction is also referred to as a thickness direction.

In the present embodiment, the light source module 1 includes the optical waveguide package 2, light-emitting elements 4 mounted on an element mount 3 in the optical waveguide package 2, a metal film 22 surrounding the element mount 3, and a lid 7 bonded to the metal film 22 to cover the element mount 3.

The optical waveguide package 2 includes a substrate 9, a cladding 12, a core 5, and the metal film 22. The substrate 9 includes a first surface 8. The cladding 12 is located on the first surface 8. The cladding 12 includes a second surface 10, a third surface 11, and fourth surfaces 14 between the second surface 10 and the third surface 11 and adjacent to the third surface 11. The cladding 12 includes the element mount 3 with an opening in the third surface 11. The core 5 is located inside the cladding 12. The core 5 includes incident surfaces 13 facing the element mount 3 and an emission surface 15 exposed from an end face of the cladding 12. The metal film 22 surrounds the element mount 3 on the substrate 9.

The metal film 22 includes a first portion 22a and second portions 22b. The first portion 22a is looped and located on the third surface 11. The second portions 22b are located on the respective fourth surfaces 14 between the second surface 10 and the third surface 11 and adjacent to the third surface 11. The core 5 and the cladding 12 form an optical waveguide layer 19. The substrate 9 may be a rectangular plate as viewed in plan.

The light source module 1 includes the optical waveguide package 2 described above, the light-emitting elements 4 located on the element mount 3, a lens 6 located on an optical path of light emitted from the core 5, and the lid 7 covering the element mount 3. The lid 7 is, for example, a box with one open surface. The lid 7 is not limited to a box, and may be a plate or may have a different shape as appropriate.

The optical waveguide layer 19 may be made of, for example, glass such as quartz or a resin. In the optical waveguide layer 19, both the core 5 and the cladding 12 may be made of glass or a resin. One of the core 5 or the cladding 12 may be made of glass, and the other may be made of a resin. The core 5 and the cladding 12 have different refractive indexes. The core 5 has a higher refractive index than the cladding 12. This difference in refractive index causes light to be fully reflected at the interface between the core 5 and the cladding 12. In other words, a material with a higher refractive index is used to form an optical waveguide, which is then surrounded by a material with a lower refractive index to confine light in the core 5 with the higher refractive index.

The light source module 1 further includes first electrodes 20 and second electrodes 21. The first electrodes 20 are located on the element mount 3 to receive the respective light-emitting elements 4. The second electrodes 21 are connected to the respective first electrodes 20 and extending outward from the element mount 3. The lens 6 is located on the optical path of light emitted from the core 5 and may collimate or condense the light from the core 5. The lens 6 may be, for example, a plano-convex lens with a straight incident surface and a convex emission surface.

The substrate 9 may be an organic wiring board including, for example, dielectric layers containing an organic material. The organic wiring board may be a printed wiring board, a build-up wiring board, or a flexible wiring board. Examples of the organic material used for the organic wiring board include an epoxy resin, a polyimide resin, a polyester resin, an acrylic resin, a phenolic resin, and a fluororesin.

The substrate 9 may be a ceramic wiring board including dielectric layers containing a ceramic material. Examples of the ceramic material used for the ceramic wiring board include sintered aluminum oxide, sintered mullite, sintered silicon carbide, sintered aluminum nitride, and sintered glass ceramic. Note that the substrate 9 may be a wiring board containing, for example, a silicon material or a glass material.

The light-emitting elements 4 include a light-emitting element 4R that emits red light, a light-emitting element 4G that emits green light, and a light-emitting element 4B that emits blue light. These light-emitting elements 4R, 4G, and 4B are, for example, light-emitting diodes (LEDs) or laser diodes. The light-emitting elements 4R, 4G, and 4B are located to have the emission end faces for the respective colors respectively facing the exposed incident surfaces 13R, 13G, and 13B facing the element mount 3 in the core 5. The core 5 includes multiple branching paths 41R, 41G, and 41B, a merging portion 17, and a joined path 18. The multiple branching paths 41R, 41G, and 41B respectively include the incident surfaces 13R, 13G, and 13B. The merging portion 17 merges the branching paths 41R, 41G, and 41B together. The joined path 18 extends between the merging portion 17 and the emission surface 15. The light-emitting elements 4R, 4G, and 4B are located on the element mount 3 to cause the optical axes of the light-emitting elements 4R, 4G, and 4B to be aligned with the centers of the respective incident surfaces 13R, 13G, and 13B of the branching paths 41R, 41G, and 41B. Note that the branching paths 41R, 41G, and 41B in the core 5 may or may not be merged by the merging portion 17, but may be, for example, independent of one another. When the branching paths 41R, 41G, and 41B are independent of one another, the branching path 41G may be straight, and the branching paths 41R and 41B may extend closer to the branching path 41G toward the emission surface 15. More specifically, the distance between the branching paths 41R and 41G in the X-direction may decrease toward the emission surface 15. The distance between the branching paths 41B and 41G in the X-direction may decrease toward the emission surface 15.

The element mount 3 may be a recess or a through-hole with an opening in the third surface 11 of the cladding 12. In another embodiment, the element mount 3 may be a through-hole extending through the cladding 12 from the third surface 11 to the second surface 10. As illustrated in FIG. 3, the element mount 3 may not fully extend through the cladding 12. At least either the first electrodes 20 or the second electrodes 21 (described later) may be located on the cladding 12. As viewed in plan, the third surface 11 of the cladding 12 includes a bond in a loop shape surrounding the opening of the element mount 3. The bond bonds the lid 7 to the third surface 11 of the cladding 12. The element mount 3 is airtightly sealed by the lid 7 to protect the light-emitting elements 4. The lid 7 may be bonded to the metal film 22 with a bond.

The lid 7 may be made of a glass material such as quartz, borosilicate, or sapphire. The bond may be made of any material that can airtightly bond the lid 7 to the cladding 12, such as AuSn or Sn—Ag—Cu solder, an Ag or Cu metal nanoparticle paste, or a glass paste.

The core 5 may contain silicon oxynitride (SiON). The cladding 12 may contain silicon oxide (SiO₂).

An example method for forming the element mount 3 will now be described. The method includes forming the second electrodes 21 on the first surface 8 of the substrate 9 and placing the optical waveguide layer 19 including the cladding 12 and the core 5 on the first surface 8 including the second electrodes 21. A portion of the cladding 12 to be the element mount 3 is removed by etching to expose the second electrodes 21 and expose portions of the first surface 8 in which the first electrodes 20 are to be formed. The first electrodes 20 are formed and connected to the respective second electrodes 21. The element mount 3 may be formed with any method other than the above method. For example, the substrate 9 on which the second electrodes 21 are formed and the optical waveguide layer 19 including the element mount 3 may be prepared separately and bonded to each other.

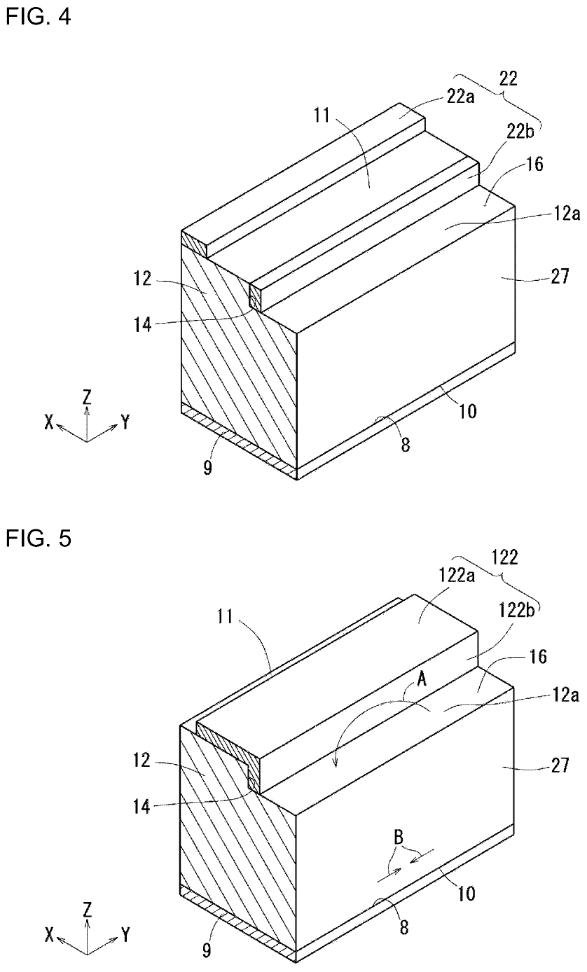

FIG. 4 is a partially enlarged perspective view of section IV in FIG. 2, illustrating the metal film 22 mounted on the cladding 12. The cladding 12 includes recesses 12a being open in the third surface 11 and side surfaces 27. The cladding 12 includes the fourth surfaces 14 as side surfaces of the respective recesses 12a. The first portion 22a and the second portions 22b in the metal film 22 are electrically disconnected from each other and separate from each other. The first portion 22a and the second portions 22b thus have low heat capacity and high heat dissipation. With this structure, less heat is transferred to the cladding 12 when the first portion 22a and the second portions 22b are heated by, for example, heat generated during the mounting of the light-emitting elements 4. The cladding 12 can thus have less heat load.

FIG. 5 is a partially enlarged perspective view of a metal film 122 in an optical waveguide package according to another embodiment of the present disclosure. Note that like reference numerals denote the corresponding components in the above embodiment, and such components will not be described repeatedly. In the present embodiment, the optical waveguide package includes the substrate 9, the cladding 12, the core 5, and the metal film 122. The metal film 122 includes a first portion 122a and second portions 122b connected to each other. The metal film 122 extends from the third surface 11 to the fourth surfaces 14. The metal film 122 is bent in a substantially L shape in a cross section perpendicular to a direction in which the fourth surfaces 14 extend. The first portion 122a and the second portions 122b are integral with each other. The metal film 122 is located on the third surface 11 and the fourth surfaces 14 and surrounds the element mount 3.

With this structure, the second portions 122b are located closer to the substrate 9 than the first portion 122a. When the metal film 122 melts and shrinks as indicated by arrows B due to heat generated during the mounting of the light-emitting elements 4, stress generated by the shrinking metal film 122 counteracts stress causing warpage of the substrate 9 due to heat as indicated by arrows A. This can reduce warpage of the substrate 9.

The warpage in the Y-direction is likely to cause misalignment between the optical axes of the light-emitting elements 4 and the optical axes of the respective incident surfaces 13R, 13G, and 13B in the core 5. The metal film 122 reduces the warpage in the Y-direction, and thus reduces the misalignment between the optical axes of the light-emitting elements 4 and the optical axes of the respective incident surfaces 13R, 13G, and 13B in the branching paths 41R, 41G, and 41B. This improves optical propagation efficiency. The second portions 122b extending in a YZ-plane direction have high resistance to warpage (bending) in the Y-direction and thus effectively reduces the warpage. In particular, the metal film 122 includes the first portion 122a and the second portions 122b connected to each other to have a bending Lshape, increasing resistance to the warpage (bending) and thus increasing robustness.

The structure may include no recess parallel to the third surface 11, or in other words, no fifth surface 16, unlike as in FIGS. 1 to 5. The fourth surfaces 14 in such a structure are portions of the respective side surfaces 27 of the cladding 12 adjacent to the third surface 11 (upper portions of the respective side surfaces 27). The fourth surfaces 14 extend in a Y-Z direction intersecting with the third surface 11. This structure also produces the same or similar advantageous effects. The structure including fifth surfaces 16 is easy to fabricate. In manufacturing multiple waveguide packages at once, for example, the fifth surfaces 16 are first formed, and the first portion 122a and the second portions 122b in the metal film 122 are formed and then cut to form the side surfaces 27. This method is more efficient than when the side surfaces 27 are formed after cutting and then the second portions 122b are formed.

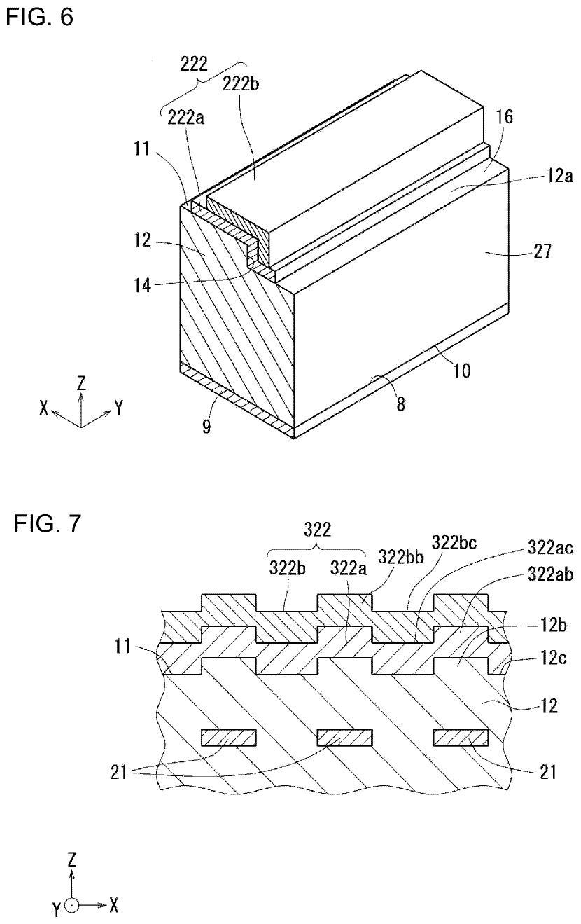

FIG. 6 is a partially enlarged perspective view of a metal film 222 in an optical waveguide package according to another embodiment of the present disclosure. Note that like reference numerals denote the corresponding components in the above embodiments, and such components will not be described repeatedly. In the present embodiment, the optical waveguide package includes the substrate 9, the cladding 12, the core 5, and the metal film 222. The cladding 12 further includes the side surfaces 27 and the fifth surfaces 16. The fifth surfaces 16 are located between the fourth surfaces 14 and the respective side surfaces 27 and parallel to the third surface 11. The fifth surfaces 16 are also bottom surfaces of recesses 12a. The metal film 222 includes a first metal film 222a and a second metal film 222b. The first metal film 222a continuously extends from the third surface 11 to the fourth surfaces 14 and to the fifth surfaces 16 of the cladding 12. The second metal film 222b overlaps the first metal film 222a and has a substantially L-shaped cross section perpendicular to the direction in which the fourth surfaces 14 extend.

The first metal film 222a may be made of, for example, TiPt. The second metal film 222b may be made of, for example, AuSn. The first metal film 222a and the second metal film 222b thus have thermal expansion coefficients satisfying the relationship of α1<α2<α3, where α1 is a thermal expansion coefficient of the cladding 12, α2 is a thermal expansion coefficient of the first metal film 222a, and α3 is a thermal expansion coefficient of the second metal film 222b. This relationship can lower the likelihood of the metal film 222 peeling off when shrinking. More specifically, when the cladding 12, the first metal film 222a, and the second metal film 222b have the thermal expansion coefficients largely different from one another, the metal film 222 may peel off when shrinking. To lower the likelihood of the first metal film 222a and the second metal film 222b peeling off, the materials are prepared to cause the relationship among thermal expansion coefficients of the cladding 12, the first metal film 222a, and the second metal film 222b to satisfy α1<α2<α3. This lowers the likelihood of deteriorating durability with heat.

The metal film 222 includes the first metal film 222a on the cladding 12 and the second metal film 222b on the first metal film 222a. When the material for the second metal film 222b has a higher thermal expansion coefficient than the material for the first metal film 222a, this structure can lower the likelihood of the films peeling off as described above.

FIG. 7 is an enlarged cross-sectional view of a metal film 322 in an optical waveguide package according to still another embodiment of the present disclosure, schematically illustrating a stacking structure of the metal film 322. The third surface 11 of the cladding 12 includes protrusions 12b at positions overlapping the respective second electrodes 21. Portions adjacent to the protrusions 12b are corresponding recesses 12c. This forms a third surface 11 with protrusions and recesses. The protrusions 12b and the recesses 12c on the cladding 12 may be formed by, for example, etching the cladding 12. The metal film 22 (322) includes a side extending in the X-direction and intersecting with a direction (Y-direction) in which the second electrodes 21 extend. The side overlaps the protrusions 12b. The protrusions and recesses on the third surface 11 of the cladding 12 are transferred to the first metal film 322a on the cladding 12. The first metal film 322a thus includes protrusions 322ab and recesses 322ac.

The first metal film 322a includes a surface facing the third surface 11 of the cladding 12 and extending along the protrusions 12b and the recesses 12c on the cladding 12. Thus, the bonding interface between the cladding 12 and the first metal surface 322a, or more specifically, the bonding interface between the metal film 322 and the cladding 12, includes protrusions and recesses. The protrusions and recesses on the first metal film 322a are transferred to a second metal film 322b. The second metal film 322b thus includes the same or similar protrusions 322bb and recesses 322bc. Thus, the bonding interface between the first metal film 322a and the second metal film 322b includes protrusions and recesses. The structure includes the third surface 11 of the cladding 12 including the protrusions 12b at the positions overlapping the respective second electrodes 21 and thus includes the protrusions 322ab on the first metal film 322a and the protrusions 322bb on the second metal film 322b.

The metal film 22 (322) includes another side extending in the X-direction at a position overlapping the core 5 extending in the Y-direction. The third surface 11 of the cladding 12 also includes the protrusions 12b at the positions overlapping the core 5. The protrusions 322ab on the first metal film 322a and the protrusions 322bb on the second metal film 322b are also at the positions corresponding to the core 5. More specifically, the protrusions 12b on the cladding 12, the protrusions 322ab on the first metal film 322a, and the protrusions 322bb on the second metal film 322b are at the positions overlapping the core 5 in front of the respective light-emitting elements 4 (in the negative Y-direction) and at the positions overlapping the respective second electrodes 21 behind the respective light-emitting elements 4 (in the Y-direction). In front of the respective light-emitting elements 4 (in the negative Y-direction), the bonding interface between the second metal film 322b and the first metal film 322a and the bonding surface between the first metal film 322a and the cladding 12 also include protrusions and recesses. In other words, the bonding interface between the metal film 322 and the cladding 12 also includes protrusions and recesses.

With the third surface 11 of the cladding 12 including the protrusions 12b, the structure increases the bonding area between the third surface 11 of the cladding 12 and the first metal film 322a and the bonding area between the first metal film 322a and the second metal film 322b. Thus, the third surface 11 of the cladding 12, the first metal film 322a, and the second metal film 322b have higher bonding strength between them. Note that the metal film 22 as a single layer and the cladding 12 also have higher bonding strength between them in the same or a similar manner.

When portions of the metal film 22 each lateral to the corresponding light-emitting element 4 (in the X-direction) extend to the corresponding fourth surface 14 (when the first portion 122a is connected to the second portions 122b), the lateral portions of the metal film 22 have higher bonding strength with the cladding 12. In this case, when bonding strength between the portions of the metal film 22 in front of and behind the respective light-emitting elements 4 and the cladding 12 is increased with the protrusions 12b on the third surface 11 of the cladding 12 as described above, the entire metal film 22 as a frame has higher bonding strength to the cladding 12. This structure reduces uneven bonding strength of the metal film 22 to the cladding 12 compared with a structure with the cladding 12 including no protrusions 12b. The metal film 22 is thus less likely to peel off from a portion with lower bonding strength.

The protrusions 12b, 322ab, and 322bb may have trapezoidal cross sections perpendicular to the longitudinal direction (Y-direction), rather than rectangular cross sections. With the trapezoidal cross sections, the protrusions 12b, 322ab, and 322bb have obtuse angles at their corners (corners between the upper surfaces and the respective side surfaces of the protrusions 12b, 322ab, and 322bb and corners between the side surfaces of the protrusions 12b, 322ab, and 322bb and the bottom surfaces of the respective recesses 12c, 322ac, and 322bc). This structure reduces stress concentration and cracks originating from the corners.

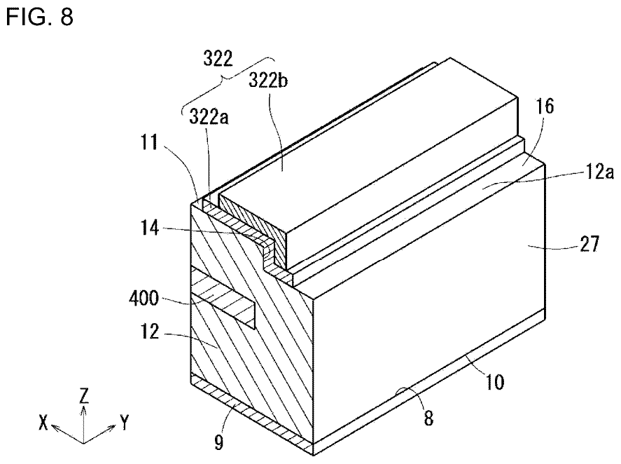

FIG. 8 is a partially enlarged perspective view of an optical waveguide package according to still another embodiment of the present disclosure. Note that like reference numerals denote the corresponding components in the above embodiment, and such components will not be described repeatedly. In the present embodiment, the optical waveguide package includes, inside the cladding 12 surrounding the element mount 3, hard layers 400 containing the same material as the core 5. The hard layers 400 may contain a material harder than the cladding 12. For example, the core 5 may contain SiON. The cladding 12 may contain SiO₂.

The hard layers 400 can be formed by etching and can be formed, for example, simultaneously with the core 5 formed by etching. The cladding 12 formed on the hard layers 400 can have a shape along the hard layers 400, or more specifically, a shape having the recesses 12a (steps). This structure thus eliminates additional work such as etching or cutting to form the recesses 12a after the cladding 12 is formed. The hard layers 400 for forming the recesses 12a may be opposite each other in the X-direction with the element mount 3 between the hard layers 400 (may be located lateral to the element mount 3). The hard layers 400 may further be opposite each other in the Y-direction with the element mount 3 between the hard layers 400 (may be located at the front and rear of the element mount 3). With the hard layers 400 surrounding the element mount 3 in this manner, the element mount 3 and the cladding 12 around the element mount 3 are less likely to deform. This structure can further reduce misalignment between, due to warpage of the element mount 3, the optical axes of the light-emitting elements 4 and the optical axes of the respective incident surfaces 13R, 13G, and 13B of the core 5. With less warpage of the third surface 11 of the cladding 12, the metal film 22 and the lid 7 on the third surface 11 of the cladding 12 are less likely to have defects in their bonding. Thus, the airtightness is easily maintained.

In still another embodiment of the present disclosure, a surface of the cladding 12 on which the metal film 322 is stacked may be roughened by chemical etching, mechanical blasting, or other roughening. The roughened surface may have an arithmetic mean roughness of, for example, about 5 to 100 nm. The first metal film 322a with a thickness of, for example, 1 to 50 μm inclusive is vapor-deposited on the front surface roughened as described above. This forms the first metal film 322a on the roughened surface of the cladding 12 and roughens the first metal film 322a. In addition, the second metal film 322b is vapor-deposited on the roughened first metal film 322a. This transfers the roughened surface to the second metal film 322b, roughening the second metal film 322b in the same or a similar manner.

The structure including the roughened cladding 12, first metal film 322a, and second metal film 322b can increase contact areas between them. Thus, the cladding 12, the first metal film 322a, and the second metal film 322b can have higher bonding strength between them, reducing the likelihood of peeling off.

In still another embodiment of the present disclosure, the light-emitting elements 4 are not limited to light-emitting diodes, but may be, for example, vertical cavity surface emitting lasers (VCSEL).

In one or more embodiments of the present disclosure, the optical waveguide package can have improved optical propagation efficiency.

In one or more embodiments of the present disclosure, the light source module can have improved optical propagation efficiency.

The optical waveguide package according to one or more embodiments of the present disclosure may have aspects (1) to (9) described below.
(1) An optical waveguide package, comprising:
a substrate including a first surface;
a cladding on the first surface, the cladding including
   a second surface facing the first surface,
   a third surface opposite the second surface,
   a fourth surface between the second surface and the third surface, the fourth surface being adjacent to the third surface, and
   an element mount being open in the third surface;
a core inside the cladding, the core including an incident surface exposed on the element mount and an emission surface exposed from an end face of the cladding; and
a metal film on the cladding, the metal film surrounding the element mount, the metal film including a first portion on the third surface and a second portion on the fourth surface.
(2) The optical waveguide package according to aspect (1), wherein
the cladding includes a recess being open in the third surface and in a side surface of the cladding, and
the fourth surface is an inner surface of the recess.
(3) The optical waveguide package according to aspect (1) or aspect (2), wherein
the first portion and the second portion are connected to each other, and
the metal film extends from the third surface to the fourth surface in a bent manner.
(4) The optical waveguide package according to any one of aspects (1) to (3), further comprising:
a layer comprising a same material as the core, the layer being inside the cladding surrounding the element mount.
(5) The optical waveguide package according to any one of aspects (1) to (3), further comprising:
a hard layer comprising a harder material than the cladding, the hard layer being inside the cladding surrounding the element mount.
(6) The optical waveguide package according to any one of aspects (1) to (5), wherein
the metal film includes
   a first metal film on the cladding, and
   a second metal film on the first metal film, and
      the second metal film has a higher thermal expansion coefficient than the first metal film.
(7) The optical waveguide package according to any one of aspects (1) to (6), wherein
the third surface of the cladding includes a protrusion at a position overlapping the metal film, and
the metal film includes a surface facing the cladding extending along the protrusion.
(8) The optical waveguide package according to aspect (7), wherein
the protrusion is at a position overlapping a side of the metal film, and the side extends in a direction intersecting with a direction in which the core extends from the incident surface.
(9) The optical waveguide package according to aspect (7) or aspect (8), wherein the protrusion has a trapezoidal cross section.

The light source module according to one or more embodiments of the present disclosure may have an aspect (10) described below.
(10) A light source module, comprising:
the optical waveguide package according to any one of aspects (1) to (9);
a light-emitting element on the element mount in the optical waveguide package; and
a lid bonded to the metal film and covering the element mount.

Although embodiments of the present disclosure have been described in detail, the present disclosure is not limited to the embodiments described above, and may be changed or varied in various manners without departing from the spirit and scope of the present disclosure. The components described in the above embodiments may be entirely or partially combined as appropriate unless any contradiction arises.

### REFERENCE SIGNS

1 light source module
2 optical waveguide package
3 element mount
4, 4R, 4G, 4B light-emitting element
5 core
6 lens
7 lid
8 first surface
9 substrate
10 second surface
11 third surface
12 cladding
13, 13R, 13G, 13B incident surface
14 fourth surface
15 emission surface
16 fifth surface
19 optical waveguide layer
20 first electrode
21 second electrode
22, 122, 222, 322 metal film
22a, 122a first portion
22b, 122b second portion
222a, 322a first metal film
222b, 322b second metal film

1. An optical waveguide package, comprising:
a substrate including a first surface;
a cladding on the first surface, the cladding including
a second surface facing the first surface,
a third surface opposite the second surface,
a fourth surface between the second surface and the third surface, the fourth surface being adjacent to the third surface, and
an element mount being open in the third surface;
a core inside the cladding, the core including an incident surface exposed on the element mount and an emission surface exposed from an end face of the cladding; and
a metal film on the cladding, the metal film surrounding the element mount, the metal film including a first portion on the third surface and a second portion on the fourth surface.

2. The optical waveguide package according to claim 1, wherein
the cladding includes a recess being open in the third surface and in a side surface of the cladding, and
the fourth surface is an inner surface of the recess.

3. The optical waveguide package according to claim 1, wherein
the first portion and the second portion are connected to each other, and
the metal film extends from the third surface to the fourth surface in a bent manner.

4. The optical waveguide package according to claim 1, further comprising:
a layer comprising a same material as the core, the layer being inside the cladding surrounding the element mount.

5. The optical waveguide package according to claim 1, further comprising:
a hard layer comprising a harder material than the cladding, the hard layer being inside the cladding surrounding the element mount.

6. The optical waveguide package according to claim 1, wherein
the metal film includes
a first metal film on the cladding, and
a second metal film on the first metal film, and
the second metal film has a higher thermal expansion coefficient than the first metal film.

7. The optical waveguide package according to claim 1, wherein
the third surface of the cladding includes a protrusion at a position overlapping the metal film, and
the metal film includes a surface facing the cladding extending along the protrusion.

8. The optical waveguide package according to claim 7, wherein
the protrusion is at a position overlapping a side of the metal film, and the side extends in a direction intersecting with a direction in which the core extends from the incident surface.

9. The optical waveguide package according to claim 7, wherein
the protrusion has a trapezoidal cross section.

10. A light source module, comprising:
the optical waveguide package according to claim 1;
a light-emitting element on the element mount in the optical waveguide package; and
a lid on the metal film and over the element mount.
